(19) United States
(12) Patent Application Publication
(10) Pub. No.: US 2014/0264134 A1
(43) Pub. Date: Sep. 18, 2014

(54) VALVE SEAL ASSEMBLY WITH RELIEF VOLUME

(71) Applicant: NOVATECH HOLDINGS CORP., Salt Lake City, UT (US)

(72) Inventors: Roy Michael Butler, Lindale, TX (US); Keith R. Peach, Ft. Worth, TX (US); Michael Preston Anderson, Frisco, TX (US)

(73) Assignee: NOVATECH HOLDINGS CORP., Salt Lake City, UT (US)

(21) Appl. No.: 14/212,369

(22) Filed: Mar. 14, 2014

Related U.S. Application Data
(60) Provisional application No. 61/790,570, filed on Mar. 15, 2013.

(51) Int. Cl. F16K 25/00

(52) U.S. Cl. CPC F16K 25/00
USPC 251/357; 29/890.124

(57) ABSTRACT

An exemplary valve seal assembly is provided that includes a valve body with one or more relief volumes that may extend circumferentially and positioned in or adjacent one or both an upper and lower member of the valve body. A compression seal positioned adjacent an opening of a relief volume and a seal that is provided primarily in a volume between the upper and lower members. In an uncompressed state, the compression seal is maintained adjacent the opening of the relief volume. In a compressed state when the valve seal assembly compressively engages a valve seat, the compression seal is compressed against the relief volume, and may be either fully or partially compressed into the relief volume. A relief volume primary angle may be provided at a desired angle, and a seal retention volume primary angle may be provided at a desired angle.

### CROSS-REFERENCE TO RELATED APPLICATIONS

Pursuant to 35 U.S.C. §119 (e), this application claims priority from, and hereby incorporates by reference for all purposes, U.S. Provisional Patent Application Ser. No. 61/790,570, entitled Valve Seal Assembly With Relief Volume, naming Roy Michael Butler, Keith R. Peach, and Michael Preston Anderson as inventors, and filed Mar. 15, 2013.

### TECHNICAL FIELD

This disclosure relates in general to valves and, in particular, but not by way of limitation, to a valve seal assembly with a relief volume.

### BACKGROUND OF THE DISCLOSURE

Valves, which may include a valve seal assembly and a valve seat, are used in various machinery and equipment. Valves used in oil field services equipment may include, for example, high pressure mud pumps, cement pumps, and pumps used in hydraulic fracturing, which are often referred to as “frac” or “fracking” pumps. Such valves operate in hostile environments that may include high pressures and/or abrasive and caustic material flow. These hostile environments may result in reduced service life, impaired operation, seal failure, and possibly catastrophic valve failure.

The cause of such reduced service life and valve failure can be due to valve seal damage or failure, valve body wear, and/or valve seat wear. The hostile environments, such as those mentioned above, may increase the occurrence of reduced service life and seal failures. Because of the complexity of equipment using valves, which includes, for example, high pressure mud pumps and frac pumps, the cost to replace a valve becomes extremely expensive, even when performing routine maintenance to replace or check such valves. Labor costs alone are often significant. Of course a valve failure, including a catastrophic failure, may completely destroy the pump or equipment in which the valve resides, potentially resulting in enormous losses.

In addition to the hostile operating environments to which a valve is often subjected, the normal pressures and forces applied to a seal as it closes and contacts the valve seat is thought to contribute to increased valve seal wear and tear. The repetitive opening and closing of a valve exerts significant forces to and throughout the valve seal, including axial forces, and such forces are believed to be non-linear and variable throughout the seal, depending on the particular geometry of the seal and how it contacts its corresponding valve seat, which in some situations may be worn and/or non-uniform. As a result of various wear and tear factors, the seal may degrade, wear, and/or erode. Such seal wear and tear reduces valve life, increases overall maintenance and outage costs, and increases the possibility of catastrophic valve failure that could result in the destruction of valuable equipment, for example, mud pumps and frac pumps.

### SUMMARY

In a first aspect, there is provided a valve seal assembly that includes a valve body with a relief volume, a compression seal positioned adjacent an opening of the relief volume, and a seal. The valve body includes an upper portion, a lower portion, and a seal retention volume. The upper portion includes an upper member that extends circumferentially, and the lower portion includes a lower member that extends circumferentially. The lower member also includes a strike angle portion that extends circumferentially and is operable to circumferentially contact a strike face of a valve seat. The seal retention volume extends circumferentially and is defined generally by the volume between an upper member seal surface of the upper member, and a lower member seal surface of the lower member. The relief volume may be considered part of the seal retention volume, extends circumferentially, and is defined generally by the volume that is adjacent a portion of one or both of the upper member seal surface of the upper member and the lower member seal surface of the lower member.

The compression seal extends circumferentially and is positioned in the seal retention volume at least partially adjacent the opening of the relief volume. The compression seal includes a primary cross-sectional length or a blocking dimension that keeps the compression seal adjacent the opening of the relief volume. The primary cross-sectional length may be any dimension, such as a height, width or any dimension that is greater than or equal to a corresponding dimension of the opening of the relief volume such that the compression seal does not enter the relief volume and/or does not further enter the relief volume.

The seal extends circumferentially and is positioned at least partially in the seal retention volume adjacent and in contact with the compression seal. The seal includes an external surface with at least a portion of the external surface provided as a seal strike surface that extends circumferentially and is operable to circumferentially contact the strike face of the valve seat when the valve seal assembly compressively engages the valve seat to compress the seal. As a result, the seal at least partially compresses or deforms the compression seal into the relief volume through its opening. This cushioning or dampening effect may provide increased seal operating properties and/or increased seal durability properties.

In other embodiments, the relief volume of the valve seal assembly is adjacent the location of an intersection of the upper member and the lower member. In other embodiments, the relief volume of the valve seal assembly is adjacent the upper member or the lower member.

In still another embodiment, the compression seal is a ring seal, for example an “O” ring in one embodiment, that has a cross-sectional area with a shape that includes at least one from the group that includes a circle, a square, a diamond, an ellipse, a rectangle, a triangle, an asymmetrical shape, a curvilinear shape, a c-cup shape, a partial circle shape, and an angled edge. In other embodiments, the compression seal includes a hollow portion within the compression seal, which may extend circumferentially, or segmented.

In yet another embodiment, the relief volume is defined by a surface that may include one or more from a curved portion, an angled portion, and a round portion.

In still yet another embodiment, the compression seal includes an elastomeric seal, a snap-in-place seal, a friction fit seal, a mechanical fit seal, a cast-in-place seal, an adhesively attached seal, a plastic seal, a urethane seal, a foam seal, a polystyrene seal, a rubber seal, and a polyurethane seal.

In still other embodiments, a rounded corner of the lower member is provided that is adjacent the strike angle portion of the lower member. The rounded corner is adjacent the seal notch and includes a convex surface that extends circumferentially. The rounded corner may be implemented with or without the seal notch, and/or with or without the relief volume and adjacent compression seal.

In yet another embodiment, the seal has a cross-sectional area with a shape that includes at least one from the group that includes a circle, a square, a diamond, an ellipse, a rectangle, a triangle, an asymmetrical shape, a curvilinear shape, and an angled edge, and the seal may be positioned in the seal retention volume using at least one from the group that includes an adhesive, a mechanical fit, a friction fit, a snap-in-place fit, and a cast-in-place fit.

In still yet another embodiment, the seal includes at least one from the group that includes a urethane, an elastomeric, a urethane that is cast-in-place, a plastic, a rubber, a dual durometer material, a multi-durometer material, and a polymer. In other embodiments, the external surface of the seal extends adjacent a top surface of the upper member of the upper portion of the valve body, while the external surface in still other embodiments may only extend adjacent a side surface of the upper member of the upper portion of the valve body, or not adjacent such side surface.

In certain embodiments, the seal is softer than the compression seal, while in other embodiments the seal is harder than the compression seal.

In still yet another embodiment, the seal strike surface of the seal contacts the strike face of the valve seat prior to the strike angle portion of the valve body contacting the strike face of the valve seat because of an offset or standoff distance in which the seal is closer to the strike face as compared to the strike angle portion of the valve body. The distance may vary depending on a particular design or material properties, and, in one embodiment the standoff distance is in a range from about 0.02 inches to about 0.11 inches.

In one embodiment, the valve seal assembly includes a valve seat operable to compressively engage the valve seal assembly.

In yet another embodiment, the valve seal assembly includes one or more additional compression seals that extend circumferentially and are positioned in the seal retention volume, and that includes one or more additional relief volumes that has an opening, extends circumferentially, and is defined generally by the volume that is adjacent a portion of one or both of the upper member seal surface of the upper member and the lower member seal surface of the lower member. The relief volumes may have a cross-sectional area with a shape that includes at least one from the group that includes a circle, a square, a diamond, an ellipse, a rectangle, a triangle, an asymmetrical shape, a curvilinear shape, an angled edge, a crown, c-cup, dovetail, a keyhole, and a semi-circle, and the relief volumes may be equal to, greater than, or less than the volume of the adjacent compression seal when not compressed.

In a second aspect, there is provided a method of making a valve seal assembly having a relief volume, and having one or more of the structural embodiments discussed above. The method includes providing a valve body with an upper portion, a lower portion, a seal, a compression seal, and a relief volume according to one or more of the embodiments described above or combinations thereof. In operation, the seal at least partially compresses or deforms the compression seal into the relief volume through its opening. This cushioning or dampening effect may increase the operational life of the seal and reduce valve maintenance costs, and reduce valve failures.

In a third aspect, there is provided a method for transitioning the valve seat assembly from an unengaged or uncompressed state with a valve seat to a compressively engaged state with the valve seat. The method includes positioning the valve seal assembly adjacent the valve seat in the unengaged state or uncompressed state, and then contacting the strike face of the valve seat to compressively engage the valve seal assembly with the valve seat to at least partially compress or deform a compression seal into at least a portion of the relief volume through the opening when a force from the adjacent seal is applied to the compression seal in response to the seal contacting the strike face of the valve seat. This cushioning or dampening effect from the compression seal/relief volume arrangement may provide enhanced valve operating properties resulting in longer performance and reduced maintenance expenses.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments, and are not necessarily drawn to scale.

FIG. 1 is a cross-sectional, side view of an exemplary valve body, according to one implementation, provided in an uncompressed state;

FIG. 2 is an expanded view of a portion of the valve body of FIG. 1 that includes a compression seal with a circular cross-sectional area;

FIG. 3 is an expanded circular cross-sectional view, similar to FIG. 2, of the valve body of FIG. 1 that includes an alternative implementation of the compression seal shown in an uncompressed state with an alternative implementation of a hollow interior that may be provided as a continuous or segmented hollow interior;

FIG. 4 is a series of cross-sectional areas of the compression seal in an uncompressed state that may be provided in certain implementations;

FIG. 5 is an upper, side perspective view illustrating a three-quarter (¾) section, side cross-sectional view of a valve body with the compression seal shown in an uncompressed state and positioned on a valve seat, in accordance with one embodiment;

FIG. 6 is a cross-sectional view of a portion of the valve seal assembly that illustrates the seal positioned adjacent to contacting the compression seal, which resides adjacent the relief volume, and a seal notch that is adjacent to or formed in the seal;

FIG. 7 is a cross-sectional side view of a valve seal assembly, similar to FIG. 1 and according to another implementation, without the compression seal and relief volume;

FIG. 8 is a cross-sectional view of a portion of the valve seal assembly of FIG. 7 with a seal strike surface extending an offset or standoff distance below a strike angle portion of the valve body;

FIG. 9 is a cross-sectional view of the portion of the valve seal assembly shown in FIG. 8 in an uncompressed state with the addition of a valve seat 200 and a strike face of the valve seat;

FIG. 10 is a cross-sectional view of a portion of a valve seal assembly, similar to FIG. 9, illustrating an implementation of the compression seal and the relief volume arranged similar to and as previously discussed in connection with FIG. 1;

FIG. 11 is a cross-sectional side view of a portion of the valve seal assembly as shown in FIG. 10 with the valve seal assembly in a compressed arrangement or a compressed state with the seat;

FIG. 12 is a cross-sectional view of a portion of a valve seal assembly with an embodiment having multiple compression seal and adjacent relief volume arrangements shown in an uncompressed state;

FIG. 13 is a series of exemplary cross-sectional areas of the relief volume, such as the relief volumes illustrated in FIG. 12; and

FIG. 14 is a cross-sectional, side view of an exemplary valve body without a seal, and similar to the valve body of FIG. 1, and illustrating a relief volume primary angle and a seal retention volume primary angle.

### DETAILED DESCRIPTION

FIG. 1 is a cross-sectional, side view of an exemplary valve body 100, according to one implementation. The valve body 100, in one embodiment, is provided generally in a cylindrical shape and includes an upper portion 110 and a lower portion 112. The upper portion 110 includes an upper member 114 that extends, generally circumferentially around the valve body 100. Similarly, the lower portion 112 includes a lower member 116 that extends, generally, circumferentially around the valve body 100.

The valve body 100 may include a seal 140 that extends circumferentially around the valve body 100 and is shown, for clarity reasons, only on the right side of FIG. 1. The combination of the valve body 100 and the seal 140 may be referred to as a valve seal assembly. The seal 140 extends circumferentially around the valve body and is generally or primarily provided in a seal retention volume 102 defined as the volume between the upper member 114 and the lower member 116. Although, as shown in FIG. 1, portions of the seal 140 may extend beyond, and even above, the seal retention volume 102, depending on a desired implementation. A portion of the seal 140 is shown extending, in one embodiment, up to and adjacent a top surface of the upper member 114. In other embodiments, the seal 140 does not extend around or above the upper member 114. For example, a seal 500 illustrated in connection with FIG. 7 provides an example where the seal 500 does not extend, either partially or fully, above or adjacent a top surface of the upper member, which is shown as upper member 510 in FIG. 7.

For simplification and clarity of FIG. 1, the seal 140 is not shown on the left side of FIG. 1. The seal retention volume 102 is shown on the left side of FIG. 1 and between the upper member 114 and the lower member 116. The upper member 114 includes an upper member seal surface 120, and the lower member 116 includes a lower member seal surface 122. The upper member seal surface 120 and the lower member seal surface 122 are provided within or may be thought to define boundary portions of the seal retention volume 102, and contact the seal 140, at least partially, within the seal retention volume 102. FIG. 1 provides an example of a valve body 100 that includes ridges or teeth to assist with the mechanical positioning of the seal 140 within the seal retention volume 102. The seal 140 may be provided using any number of known or available materials, for example, polyurethane, rubber, plastic, urethane, and any other known or available substance providing the desired characteristics, for example an elastomeric, polymer or polymeric material. In one embodiment, the seal 140 is implemented as a urethane that is cast in place within the seal retention volume 102. In alternate embodiments, a preformed or snap in place seal can be molded separately from the valve body 100. The preformed seal is positioned into the seal retention volume 102. In other embodiments, the seal 140 is provided within the seal retention volume 102 using an adhesive provided in one or more locations, and in still other embodiments, a mechanical or friction fit may be utilized. The adhesive implementation may include an adhesive between the seal 140 and portions of the upper member seal surface 120 and the lower member seal surface 122.

A relief volume 104 is shown in FIG. 1 and is provided circumferentially within the seal retention volume 102. In this embodiment, the relief volume 104 is formed at the intersection of the upper member seal surface 120 and the lower member seal surface 122, and may be considered part of the seal retention volume 102 or separately. In other embodiments, the relief volume 104 may be provided entirely within the upper member 114 or the lower member 116. For example, the relief volume 104 may be provided and defined by a portion of the upper member seal surface 120 or the lower member seal surface 122. Examples of such are discussed below and illustrated in FIGS. 12 and 13. In other certain embodiments, the seal retention volume 104 is formed of circumferential portions, which are not continuous around the cylindrical shape of the valve body 100.

The relief volume 104 shown in FIG. 1 is provided adjacent the compression seal 106 while the compression seal 106 is generally in an uncompressed state. The uncompressed state refers to the fact that the valve body, and the seal 140, is not in a compressively engaged state with a valve seat, such as the strike face of a valve seat. In one embodiment, the compression seal 106 is retained in place or positioned adjacent the relief volume 104, prior to the installation of the seal 140, using a friction fit, for example the way a rubber band may reside around an object when the rubber band is in a stretched or partially extended state, or using an adhesive or other available means. Thereafter, when the seal 140 is installed or positioned in place generally within, but not necessarily entirely within, the seal retention volume 102, the seal 140 will reside adjacent the compression seal 106 while the compression seal 106 is adjacent the relief volume 104.

The compression seal 106 may be implemented, in one embodiment, as a ring seal, or an “O”-ring. The cross-section of the compression seal 106 may be provided in any number of geometric shapes, for example the geometric shape shown in FIG. 4. In addition to the generally circular cross-sectional shape illustrated in FIG. 1 of the compression seal 106, FIG. 4 illustrates a square cross-section 180, a diamond cross-section area 182, a rectangular cross-sectional area 184, an elliptical cross-sectional area 186, a triangular cross-sectional area 188 and a curved and angle cross-sectional area 190. In other embodiments, the cross-sectional area may be any of a variety of shapes, such as a semi-circular or half-circular cross-sectional area, an angled edge, a curvilinear-shaped cross-sectional area, a C-cap cup-shaped cross-sectional area, a key-hole shaped cross-sectional area, an asymmetrical cross-sectional area, or any other cross-sectional area that provides the desired characteristics. Although the various cross-sections of the compression seal 106 of FIG. 4 are shown oriented in a certain way, it should be understood that they may be rotated or oriented in any desired manner in an actual implementation. For example, the rectangular cross-sectional area 184 and the elliptical cross-sectional area 186 are shown generally in FIG. 4 residing on a horizontal plane along their longer, longitudinal dimension. In an actual implementation, these cross-sectional areas may be provided at any desired angle from the horizontal plane. Just as the cross-sections of the compression seal 106 may be provided in any of a variety of geometric shapes, the relief volume 104, including the cross-section to the relief volume 104, may be provided in any of a variety of geometric shapes, such as those illustrated in FIGS. 12 and 13. In certain embodiments, the compression seal 106 in an uncompressed state may have a volume that is greater than, less than, or equal to the volume of the relief volume 104. In a preferred embodiment, the relief volume 104 has a volume that is less than or equal to the volume of the compression seal 106, when in an uncompressed state.

The compression seal 106 of FIG. 1 is shown provided adjacent an opening to the relief volume 104 such that the diameter 108 of the circular compression seal 106 is larger than a dimension defining the opening to the relief volume 104. This prevents the compression seal 106 from moving into the relief volume 104, unless, as explained below, forces, for example axial forces, are provided at the compression seal 106 to deflect or compress the compression seal 106 partially into or, in some embodiments, fully into the relief volume 104. For example, the seal 140 may reside adjacent the compression seal 106 and, in operation, when the valve body 100 closes onto a valve seat, not shown in FIG. 1, a seal strike surface 126 contacts and compresses or deflects when contacting a corresponding strike face of a valve seat such that the seal 140 provides a force, which may be referred to as an axial force or angled force, that is distributed to the compression seal 106, which results in the compression and deflection of the compression seal 106 into the relief volume 104 through the opening. The compression seal 106 may be either partially or fully deflected or compressed, depending on the particular implementation, into the relief volume 104.

A seal notch 142 is provided in FIG. 1 that extends circumferentially and is formed, in one embodiment, in the seal 140 at a location between the external surface of the seal strike surface 126 and the lower member 116. The lower member 116 also includes a strike angle portion 118 that is provided, in operation, to contact a corresponding strike face of a valve seat when the valve seal assembly is compressed with a corresponding valve seat to close the valve. The seal notch 142, in one embodiment, may include a curvature, for example a concave surface, that extends from or adjacent to an edge of the seal strike surface 126 of the external surface of the seal 140 towards the lower member 116 of the lower portion 112 of the valve body 100. In certain implementations, the radius of curvature is between about 0.06 inches to 0.1 about inches, but may vary outside this range in other implementations.

A rounded lower portion or member 144 is provided adjacent the seal notch 142 in certain implementations. The surface of the rounded lower member 144 may be thought of as defining a boundary or surface of the volume of the seal notch 142, or possibly being included as part of the seal notch 142. The rounded lower member 144 may be implemented with a portion that is convex. In a preferred implementation, the radius of curvature of the convex portion of the rounded lower portion or member 144 may be in a range from about 0.04 inches to about 0.06 inches, and may be provided as about 0.06 inches in one implementation. Other implementation may include a radius of curvature outside such range.

In operation, as the valve body 100 and the seal 140, which may be referred to as the valve seal assembly, are moved towards a corresponding valve seat to close or provide compression, the seal strike surface 126 contacts a corresponding portion of a strike face of a valve seat. As the compression continues, the strike angle portion 118 of the lower member 116 of the valve body 100 will also contact a corresponding portion of a strike face of the valve seat. As a result, the seal 140 is compressed and provides forces towards the compression seal 106, resulting in the compression and deformation or deflection of the compression seal 106 into the relief volume 104 through the opening. This arrangement may provide added durability and reduce maintenance costs by allowing such movement which is believed to reduce internal stresses and forces in the seal 140 and/or provide a cushioning or dampening effect when the valve is closed. This may increase the life and/or performance of the seal 140.

Test data indicates that the arrangement that includes the compression seal 106 and the relief volume 104, as shown and discussed, increases the overall life of the valve seal assembly. Experiments with valve seal assemblies used in actual frac pumps during frac operations have shown decreased wear of both the seal 106, as well as the valve body 100, as compared to valve seal assemblies not employing the arrangement that includes the compression seal 106 and the relief volume 104 as shown and discussed herein.

The following “Table 1” compares the wear performance of two similar valve bodies, one with the compression seal 106 and the relief volume 104 arrangement as shown and discussed herein, and one without such an arrangement. The valve seal assembly “A” as shown in Table 1 includes the compression seal 106 and the relief volume 104 arrangement, while the valve seal assembly “B” does not include such an arrangement. Valve seal assemblies “A” and “B” were tested in both the discharge portion of a frac pump and the suction portion of a frac pump for extended periods of time to ensure that valve wear was present. The wear of the valve seal assemblies was measured by determining the total weight of the valve seal assemblies before and after such tests. Thus, the greater the percentage weight (or mass) loss, the greater the wear. The total loss of weight of the valve seal assemblies is believed to be from a combination of wear of the seal 140 and the valve body 100.

TABLE 1

| Valve Seal Assembly Test in a Frac Pump | | % Total Weight Loss |
|---|---|---|
| Combined Suction and Discharge | “A” | 0.094% |
| Valve Seal Assemblies Weight Loss | “B” | 0.180% |

Table 1 plainly demonstrates that valve seal assembly “A”, which includes the compression seal 106 and the relief volume 104 arrangement, suffers less wear in operation than the valve seal assembly “B”, which does not include such an arrangement. This is true when the valve seal assemblies are operating in either the discharge or suction portions of the frac pump. The “Combined Suction and Discharge Valve Seal Assemblies Weight Loss” rows show the average percentage weight loss of the results of the discharge and suction valve seal assemblies. Thus, the valve seal assembly “A”, which includes the compression seal 106 and the relief volume 104 arrangement, is shown in these tests providing significant wear advantages as compared to the valve seal assembly “B”.

The seal notch 142 provides a volume or relief volume in which the seal 140 may expand without breaking or tearing the internal bonds or structures of the seal 140 resulting in possible destruction, flaking, or excessive wearing of the seal 140 at or near the interface between the seal 140 and the lower member 116. In other embodiments, one or the other of the seal notch 142 or the compression seal 106/relief volume 104 arrangement may be provided.

FIG. 2 is an expanded view of the area as indicated in FIG. 1. FIG. 2 illustrates a circular cross-sectional area of the compression seal 106 shown frictionally positioned adjacent the relief volume 104. FIG. 2 assumes that the valve body 100 is not compressed, which may be referred to as an uncompressed state. While a compressed state is not illustrated in FIG. 2, it is useful to understand the compressed state, which may be illustrated, in one embodiment, when the seal strike surface 126 is externally compressed, for example when the valve body 100 closes the valve by compressing the seal strike surface 126 of the seal 140 with a strike face of a valve body. In such a case, the compression seal 106 is compressed through forces transmitted by the seal 140 being compressed through the forces at the seal strike force 126. In certain embodiments, this will compress all or some of the compression seal 106 into some or all of the relief volume 104. This is discussed more fully below.

A diameter 108 is shown in FIG. 2 and may be referred to as a blocking dimension or a primary cross-sectional link of the compression seal 106 as it resides adjacent the opening of the relief volume 104 in an uncompressed state. The corresponding adjacent dimension at the relief volume engages the surface of the compression seal 106 to prevent the compression seal 106 from entering or further entering the relief volume 104 in this uncompressed state.

In one embodiment, the compression seal 106 may be friction fit into place, snap-in-place, cast-in-place, adhesively attached, and may be made of any known or available material that provides a desired compression and/or mechanical properties. In a preferred embodiment, the compression seal 106 is made of a material that is softer than the corresponding material of the seal 140. In other embodiments, however, the seal 140 may be provided with a material that is softer than the compression seal 106. In still other embodiments, the compression seal 106 may be made of an elastomeric material, a urethane material, a plastic material, a foam material, a polystyrene material, a polymer, a rubber material, a composite material, and/or combinations of materials.

FIG. 3 is a circular cross-sectional area, similar to FIG. 2, which illustrates the compression seal 106 having a cross-sectional area that includes a curved portion and an angled portion facing the relief volume 104 while the valve body 100 and seal 140 are in an uncompressed state. In alternative embodiments, the compression seal 106 may include a hollow core or hollow volume within the compression seal 106 as illustrated in FIG. 3. For example, a hollow interior 128 is shown in FIG. 3 and is provided within the compression seal 106. The hollow interior 128 may be provided as a continuous hollow interior or may be segmented or non-continuous. In other embodiments, multiple hollow interiors may be provided in the compression seal 106. When the valve is provided in a compressed state, not shown in FIG. 3, the compression seal 106 will compress and fully or partially enter the relief volume 104. Depending on the compositions and exact geometric shapes of the compression seal 106 and the seal 140, as well as the relief volume 104 and applied forces, for example, the compression of compression seal 106 during a compressed state may be uniform, non-uniform, symmetrical, and/or asymmetrical.

FIG. 5 is an upper, side perspective view illustrating a three-quarter (¾) section, side cross-sectional view of the valve body 100 positioned on a valve seat 200. The valve body 100 includes the external surface of the seal 140 shown extended adjacent the top surface of the upper member 114, such as that shown on the right side of FIG. 1. The seal 140 is shown extending circumferentially around the valve body 100. The compression seal 106 is shown extending circumferentially around the valve body 100 and adjacent the seal 140 and the circumferentially extending relief volume 104.

The seal strike surface 126 is shown in contact with a portion of a strike face 202 of the valve seat 200. The seal strike surface 126 of the seal 140 is shown contacting the portion of the strike face 202, which will be provided at a corresponding angle to allow for a desired contact area, of the valve seat 200. The strike angle portion 118 of the lower portion of the valve body 100 is shown slightly above the surface of a portion of the strike face 202 of the valve seat 200. This indicates that the valve seal assembly is not in a compressed state as the strike angle portion 118 is slightly above the strike face 202 because of an “offset” or “standoff” distance in which the seal strike surface 126 extends closer to the strike face 202 as compared to the strike angle portion 118.

The valve body 100 and the valve seat 200 may be constructed of any known or desirable materials using any preferred process. The valve body 100, as well as the valve seat 200 may be provided using any known or desirable metal. For example, in certain embodiments, the valve body 100 and the valve seat 200 may be provided using cast steel, and in a tubular or circular shape. It should be understood, however, that any known or available metal, steel or desired material may be used for the manufacture of the valve body 100 and the valve seat 200. For example, such materials may include ASI 8620 alloy steel, ASI 4140, 4150, 4320, carbon steel, or other alloys providing desirable characteristics. Such materials may be heat treated, hardened, for example, air hardened, and carbonized. But other processes and materials may be utilized as well.

Under compression when the valve seal assembly is in operation and sealingly engaged with the valve seat 200, both the seal strike surface 126 and the strike angle portion 118 of the lower member of the valve body 100 will be in contact with the corresponding portion of the strike face 202 of the valve seat 200. This may be referred to as being in a compressed state. Although not shown in FIG. 2, the valve seal assembly may be implemented to sealingly engage with the valve seat 200 by forces applied to either the top or bottom portion of the valve body 100.

When the valve body 100 is sealingly engaged with the valve seat 200, this prevents the flow of fluids and/or solids, such as abrasive constituents that may flow through valves in a mud pump or frac pump, for example. Such oil field surfaces, equipment and pumps may operate at extremely high pressures for example pressures extending as high as, for example, 15,000 psi to 20,000 psi. In certain implementations, the embodiments and aspects described herein are believed to provide desirable operational characteristics in high pressure applications and/or applications involving abrasive constituents.

FIG. 6 is a cross-sectional view of a portion of a valve seal assembly. The seal 140 is shown contacting the compression seal 106, which resides adjacent the relief volume 104. It should be understood that the relief volume 104, although illustrated having a curved surface, may be provided in any desirable shape. For example, the relief volume 104 may be provided with an opening and/or surfaces that are beveled or angled, elliptical, or in any other desired shape, for example a desired shape that meshes or mates with the portion of the compression seal 106 that is directly adjacent the relief volume 104. The relief volume 104 will include some dimensional barrier such that the compression seal 106 will, in one embodiment, reside adjacent such dimensional barrier and, in an uncompressed state, shall not deflect or deform into the residual volume 104. Under compression or applied forces, the particular compression seal 106 may then be deflected or compressed through the forces applied to the seal strike surface 126 and ultimately to the compression seal 106 such that a portion or all of the compression seal 106 is compressed or deflected into the relief volume 104. Of course, if the relief volume 104 is not large enough to contain the entire volume of the compression seal 106 when it is compressed, the entire compression seal 106 will not be compressed into the relief volume 104. However, certain implementations of the compression sleeve 106 are provided such that compression seal 106 may deform into a smaller volume and may fully reside within the relief volume 104 that may be provided at a smaller volume than the uncompressed volume of the compression volume 106. In other embodiments, the relief volume 104 is not provided and the compression seal 106 can be located at one or more of the following: the intersection of the upper member seal surface 120 and the lower member seal surface 122, the upper member seal surface 120, or the lower member seal surface 122. In another embodiment, the compression seal 106 is not provided and the relief volume can be located at one or more of the following: at the intersection of the upper member seal surface 120 and the lower member seal surface 122, the upper member seal surface 120, or the lower member seal surface 122.

The distance in which the seal strike surface 126 of the seal 140 extends closer to a corresponding strike face of a valve seat as compared to the strike angle portion 118 may be referred to as the offset or standoff distance. Under compression, the offset distance is reduced or eliminated by the compression of the seal 140 until at least portions of the seal strike surface 126 and the strike angle portion 118 are no longer at an offset. This offset distance may vary as the seal 140 wears and portions of the seal strike surface 126 may erode or wear away. Similarly, wear may occur at the strike angle portion 118 of the lower member 116 of the valve body 100. In a preferred implementation, the offset or standoff distance, while the valve is in an uncompressed state, may be about 0.06 inches, or may be provided in a range of distances that include from about 0.02 inches to about 0.11 inches. It should be understood that such distance may vary depending on the angles of the surfaces, and the properties of the materials used, such as the seal 140, and, as such, other offset/standoff distances outside of the preferred ranges just mentioned may be used.

FIG. 7, which was briefly discussed above, is a cross-sectional view of a valve seal assembly, similar to FIG. 1. The valve seal assembly does not include a compression seal within the seal 500, and does not include a relief volume of a valve body 400. The valve body 400 does include a seal notch and rounded lower portion of a lower member 512. The seal 500 is positioned generally or primarily between the lower member 512 and an upper member 510. The seal 500 does not extend, either partially or fully, above or adjacent a top surface of the upper member 510, in contrast to the seal 140 of FIG. 1.

An angle 422, which may be measured from a horizontal surface, is provided to define a chamfer or edge break portion of the external surface of the seal 500. In certain implementations, this may be provided at 60 degrees above the horizontal, or 30 degrees in addition to an angle 424, which may be referred to as a seal strike surface angle. The seal strike surface angle 424 is preferably provided at 30 or 25 degrees, depending on the strike angle of the corresponding valve body, or as desired.

FIG. 8 is a partial cross-sectional view of the valve seal assembly of FIG. 7 that includes the valve body 400 and the seal 500 provided within a volume formed, generally or primarily, between the upper member 510 of the valve body 400 and the lower member 512. In this embodiment of the seal 500, the external surface of the seal 500 does not extend adjacent the top surface of the upper member 510, as just discussed.

A seal notch 520 is shown that extends circumferentially and is formed in or provided adjacent the seal 500 and adjacent an end of a seal strike surface 504 and a strike angle portion 540 formed in the lower member 512 of the valve body 400. A standoff or offset 420 is shown illustrating the uncompressed distance between the strike angle portion 540 of the valve body and the seal strike surface 504 of the seal 500. This allows the seal strike surface 504 to engage or contact a corresponding valve seat prior to the strike angle portion 540. In a preferred embodiment, the angle of the seal strike surface 504 and the strike angle portion 540 are provided at the same or similar angle, but are provided at a standoff or offset distance. These angles and distance are discussed above.

As mentioned above, the valve seal assembly as shown in FIG. 8 does not include a relief volume or compression seal but does include the seal notch 520, which may be provided as discussed above. The seal notch 520 may include a seal notch depth 428, a seal notch width 426, and includes a curvilinear or other surface portion of the lower member 512. The seal notch depth 428 may include any desirable depth, and may be provided at a depth from the range from about 0.04 inches to about 0.12 inches. In one embodiment, the seal notch depth 428 is provided at 0.08 about inches, but the present disclosure should in no way be limited to these exemplary distances. The seal notch width 426 may include any desirable width, and may be provided at a distance from the range from about 0.03 inches to about 0.12 inches. In one embodiment, the seal notch width 426 is provided at about 0.06 inches, but the present disclosure should in no way be limited to these exemplary distances.

An angled external seal surface 506 is also provided in FIG. 8 and this may be referred to as a chamfered or edge break. This illustrates an alternative external surface contour or profile, which may be provided as desired.

In operation, as the valve seal assembly contacts a corresponding valve seat and the seal strike surface 504 compresses the seal 500 until the strike angle portion 540 of the valve body also contacts the valve seat. The seal notch 520 provides mechanical stress relief in adjacent areas of the seal 500. This may extend the life of seal 500 and prevent flaking or “nibbling” erosion at this interface or area.

FIG. 9 is a cross-sectional view of the valve seal assembly shown in FIG. 8 with the addition of the valve seat 200 and the strike face 202. The arrangement clarifies that the seal strike surface 504 contacts the strike face 202 prior to the strike angle portion 540. In one embodiment, the strike angle portion 540 will be made of material that is the same as the strike face 202 of the valve seat 200.

FIG. 10 is a cross-sectional view of a portion of a valve seal assembly, similar to FIG. 9, illustrating an implementation of a compression seal and a relief volume arranged as previously discussed and illustrated in connection with FIG. 1 et al., and with the seal 500 extending upwardly to the top surface of the top member of the valve body. The valve seal assembly, including the seal 500, is shown in an uncompressed state with the valve seat 200.

FIG. 11 is a cross-sectional side view of a portion of the valve seal assembly as shown in FIG. 10 with the valve seal assembly in a compressed arrangement or a compressed state with the seat 200. The surfaces of the seal 500 and the valve body contact a corresponding portion of the surface of the valve seat 200, such as the strike face 202 of the valve seat 200 of FIG. 9, that are provided at a similar angle. The compression of the seal 500 is shown directing a force to the compression seal which results in the compression and/or deflection of the compression seal either partially or fully into the relief volume.

FIG. 12 is a cross-sectional view of a portion of a valve seal assembly with an embodiment having multiple compression seal and adjacent relief volume arrangements shown in an uncompressed state. The seal 500 and the upper and lower members of a valve body, similar to FIG. 10, include multiple compression seal and adjacent relief volume pairs shown in an uncompressed state. A relief volume 600 is shown provided in the upper member of the valve body and adjacent a compression seal 606, while a relief volume 604 is shown provided in the lower member of the valve body and adjacent a compression seal 610. The relief volume has an opening dimension that prevents or blocks the valve seal in the uncompressed state from entering the corresponding relief volume. The number and varied locations of the relief volume/compression seal pairs illustrate that some implementations may include multiple compression seal/relief volumes arrangements located where desired. A relief volume 602 and an adjacent compression seal 608 are shown at the intersection of the upper and lower member of the valve body as illustrated in various prior drawings. The size, geometric shape and arrangement of both the relief volumes and compression seals may be varied, as illustrated in FIG. 12.

FIG. 13 provides various exemplary cross-sectional areas of a relief volume, such as the relief volumes illustrated in FIG. 12. These exemplary cross-sectional areas include an opening shown along a bottom edge and include a rounded area 702, a dovetail area 704, a crown area 706, a square or rectangular area 708, an angled top on a curved area 710, a partial diamond area 712, a P shaped area 714, a keyhole 716, and a triangle area. The cross-section of the relief volume may be provided in any number of other geometric shapes. The relief volume, similar to the cross-sectional area of the compression seal, may have an asymmetrical cross-sectional area, or any other cross-sectional area that provides the desired characteristics. Although the various cross-sections and opening to the various relief volumes of FIG. 13 are shown oriented in a certain way, it should be understood that they may be rotated or oriented in any desired manner.

FIG. 14 is a cross-sectional, side view of the exemplary valve body 100 without a seal, and similar to or the same as the valve body 100 of FIG. 1, and illustrating a relief volume primary angle A, and a seal retention volume primary angle B. The valve body 100 includes the seal retention volume 102 defined at least partially between the upper member seal surface 120 and the lower member seal surface 122.

The seal retention volume 102 is configured to and/or operable to retain, at least partially, a seal, such as a polyurethane, polymer, or elastomeric seal. As shown and discussed herein, any of a variety of seal types may be used, and any number of techniques and/or technologies may be used to assist with the retention of at least a portion of the seal in or adjacent the seal retention volume 102. For example, the seal may be mechanically retained or assisted using one or more serrations positioned on or adjacent either or both the upper member seal surface 120 and the lower member seal surface 122.

The seal retention volume 102 may be further defined by the seal retention volume primary angle B as shown in the cross-sectional, side view of FIG. 14. This angle may be defined as the angle between a line or plane that runs generally along or adjacent the surface of the upper member seal surface 120, and a line or plane that runs generally along or adjacent the surface of the lower member seal surface 122. In one embodiment, the seal retention volume primary angle B may be provided at an angle greater than zero degrees to less than about 80 degrees, from about 30 degrees to less than about 55 degrees, or from about 42 to about 49 degrees.

The seal retention volume 102 may be further defined by the relief volume primary angle A as illustrated in the cross-sectional, side view of FIG. 14. This angle may be defined as the angle between a line or plane that runs generally along or adjacent the surface of a upper member surface of the relief volume 104, and a line or plane that runs generally along or adjacent the surface of a lower member surface of the relief volume 104. In one embodiment, the relief volume primary angle A may be provided at an angle greater than zero degrees to less than 80 degrees, from about 20 degrees to about 60 degrees, from about 30 degrees to about 50 degrees, or from about 32 degrees to 42 degrees.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A valve seal assembly having a relief volume, the valve seal assembly comprising:
a valve body that includes:
an upper portion that includes an upper member that extends circumferentially;
a lower portion that includes a lower member that extends circumferentially, and wherein the lower member includes a strike angle portion that extends circumferentially and is operable to circumferentially contact a strike face of a valve seat when, in operation, the valve seal assembly engages the valve seat;
a seal retention volume that extends circumferentially and is defined generally by the volume between an upper member seal surface of the upper member and a lower member seal surface of the lower member, and that includes a relief volume having an opening and that extends circumferentially and is defined generally by the volume that is adjacent a portion of one or both of the upper member seal surface of the upper member and the lower member seal surface of the lower member;
a compression seal that extends circumferentially and is positioned in the seal retention volume at least partially adjacent the opening of the relief volume; wherein the compression seal includes a primary cross-sectional length that is greater than or equal to a height of the opening of the relief volume; and
a seal that extends circumferentially and is positioned at least partially in the seal retention volume adjacent and in contact with the compression seal, the seal having an external surface with at least a portion of the external surface provided as a seal strike surface that extends circumferentially and is operable to circumferentially contact the strike face of the valve seat when the valve seal assembly compressively engages the valve seat to compress the seal, and wherein the compression seal is operable to at least partially compress or deform and at least partially extend into the relief volume through the opening when a force from the adjacent seal is applied to the compression seal in response to the seal being compressed.

2. The valve seal assembly according to claim 1, wherein the relief volume is adjacent the location of an intersection of the upper member seal surface of the upper member and the lower member seal surface of the lower member.

3. The valve seal assembly according to claim 1, wherein the relief volume is adjacent the upper member seal surface of the upper member.

4. The valve seal assembly according to claim 1, wherein the relief volume is adjacent the lower member seal surface of the lower member.

5. The valve seal assembly according to claim 1, wherein the compression seal is a ring seal.

6. The valve seal assembly according to claim 5, wherein the compression seal has a cross-sectional area with a shape that includes at least one from the group that includes a circle, a square, a diamond, an ellipse, a rectangle, a triangle, an asymmetrical shape, a curvilinear shape, a c-cup shape, a partial circle shape, and an angled edge.

7. The valve seal assembly according to claim 1, wherein the compression seal includes a hollow portion within the compression seal.

8. The valve seal assembly according to claim 1, wherein the compression seal is an O-ring.

9. The valve seal assembly according to claim 1, wherein the relief volume is defined by a surface with at least a portion that includes at least one from the group that includes a curved portion, an angled portion, and a round portion.

10. The valve seal assembly according to claim 1, wherein the compression seal includes at least one from the group that includes an elastomeric seal, a snap-in-place seal, a friction fit seal, a mechanical fit seal, a cast-in-place seal, an adhesively attached seal, a plastic seal, a urethane seal, a foam seal, a polystyrene seal, a rubber seal, and a polyurethane seal.

11. The valve seal assembly according to claim 1, further comprising:
a rounded corner of the lower member is provided adjacent the strike angle portion of the lower member, and wherein the rounded corner includes a convex surface that extends circumferentially and adjacent the seal strike surface of the external surface of the seal.

12. The valve seal assembly according to claim 1, wherein the seal has a cross-sectional area with a shape that includes at least one from the group that includes a circle, a square, a diamond, an ellipse, a rectangle, a triangle, an asymmetrical shape, a curvilinear shape, and an angled edge.

13. The valve seal assembly according to claim 1, wherein the seal is positioned in the seal retention volume using at least one from the group that includes an adhesive, a mechanical fit, a friction fit, a snap-in-place fit, and a cast-in-place fit.

14. The valve seal assembly according to claim 1, wherein the seal includes at least one from the group that includes a urethane, an elastomeric, a urethane that is cast-in-place, a plastic, a rubber, and a polymer.

15. The valve seal assembly according to claim 1, wherein the external surface of the seal extends adjacent a top surface of the upper member of the upper portion of the valve body.

16. The valve seal assembly according to claim 1, wherein the external surface of the seal extends adjacent a side surface of the upper member of the upper portion of the valve body.

17. The valve seal assembly according to claim 1, wherein the seal is softer than the compression seal.

18. The valve seal assembly according to claim 1, wherein the seal is harder than the compression seal.

19. The valve seal assembly according to claim 1, wherein the seal is made of a multi-durometer material.

20. The valve seal assembly according to claim 1, wherein, in operation when the valve seal assembly contacts the valve seat, the seal strike surface of the seal contacts the strike face of the valve seat prior to the strike angle portion of the valve body contacting the strike face of the valve seat.

21. The valve seal assembly according to claim 1, wherein the seal strike surface of the seal is positioned a standoff distance closer to the strike face of the valve seat than the strike angle portion of the valve body is positioned from the strike face of the valve seat.

22. The valve seal assembly according to claim 21, wherein the standoff distance is in a range from about 0.02 inches to about 0.11 inches

23. The valve seal assembly according to claim 1, further comprising:
a valve seat operable to compressively engage the valve seal assembly.

24. The valve seal assembly according to claim 1, further comprising:
one or more additional compression seals that extend circumferentially and are positioned in the seal retention volume; and
one or more additional relief volumes that have an opening, extend circumferentially, and is defined generally by the volume that is adjacent a portion of one or both of the upper member seal surface of the upper member and the lower member seal surface of the lower member, wherein the one or more additional compression seals is positioned adjacent the opening of a corresponding one of the one or more additional relief volumes, and wherein the one or more additional compression seals includes a dimension that is greater than an adjacent dimension of the corresponding opening of the adjacent relief volume; and wherein the compression of the seal strike face of the seal is operable to compress the one or more additional compression seals so that the one or more additional compression seals extend at least partially through the corresponding opening of the adjacent relief volume.

25. The valve seal assembly according to claim 24, wherein the relief volume has a cross-sectional area with a shape that includes at least one from the group that includes a circle, a square, a diamond, an ellipse, a rectangle, a triangle, an asymmetrical shape, a curvilinear shape, an angled edge, a crown, c-cup, dovetail, a keyhole, and a semi-circle.

26. The valve seal assembly according to claim 24, wherein the volume of any of the relief volumes may be equal to, greater than, or less than the volume of the adjacent compression seal when not compressed.

27. A method of making a valve seal assembly having a relief volume, the method comprising:
providing a valve body that includes:
an upper portion that includes an upper member that extends circumferentially;
a lower portion that includes a lower member that extends circumferentially, and wherein the lower member includes a strike angle portion that extends circumferentially and is operable to circumferentially contact a strike face of a valve seat when, in operation, the valve seal assembly engages the valve seat;
a seal retention volume that extends circumferentially and is defined generally by the volume between an upper member seal surface of the upper member and a lower member seal surface of the lower member, and that includes a relief volume having an opening and that extends circumferentially and is defined generally by the volume that is adjacent a portion of one or both of the upper member seal surface of the upper member and the lower member seal surface of the lower member;
providing a compression seal that extends circumferentially and is positioned in the seal retention volume at least partially adjacent the opening of the relief volume; wherein the compression seal includes a primary cross-sectional length that is greater than or equal to a height of the opening of the relief volume; and
providing a seal that extends circumferentially and is positioned at least partially in the seal retention volume adjacent and in contact with the compression seal, the seal having an external surface with at least a portion of the external surface provided as a seal strike surface that extends circumferentially and is operable to circumferentially contact the strike face of the valve seat when the valve seal assembly compressively engages the valve seat to compress the seal, and wherein the compression seal is operable to at least partially compress or deform and at least partially extend into the relief volume through the opening when a force from the adjacent seal is applied to the compression seal in response to the seal being compressed.

28. A method for transitioning a valve that includes a valve seal assembly and a valve seat from an unengaged state to a compressively engaged state, the method comprising:
positioning the valve seal assembly adjacent the valve seat in the unengaged state, wherein the valve seat includes a body with a strike face operable to engage at least a portion of the valve seal assembly, which includes a seal strike surface of a seal and a strike angle portion, when the valve seal assembly and the valve seat are provided in the compressively engaged state, and wherein the valve seal assembly includes:
a valve body that includes:
an upper portion that includes an upper member that extends circumferentially;
a lower portion that includes a lower member that extends circumferentially, and wherein the lower member includes the strike angle portion that extends circumferentially and is operable to circumferentially contact the strike face of the valve seat when, in operation, the valve seal assembly engages the valve seat;
a seal retention volume that extends circumferentially and is defined generally by the volume between an upper member seal surface of the upper member and a lower member seal surface of the lower member, and that includes a relief volume having an opening and that extends circumferentially and is defined generally by the volume that is adjacent a portion of one or both of the upper member seal surface of the upper member and the lower member seal surface of the lower member;
a compression seal that extends circumferentially and is positioned in the seal retention volume at least partially adjacent the opening of the relief volume; wherein the compression seal includes a primary cross-sectional length that is greater than or equal to a height of the opening of the relief volume; and wherein the seal extends circumferentially and is positioned at least partially in the seal retention volume adjacent and in contact with the compression seal, the seal having an external surface with at least a portion of the external surface provided as the seal strike surface that extends circumferentially and is operable to circumferentially contact the strike face of the valve seat when the valve seal assembly compressively engages the valve seat to compress the seal, and wherein the compression seal is operable to at least partially compress or deform and at least partially extend into the relief volume through the opening when a force from the adjacent seal is applied to the compression seal in response to the seal being compressed; and
engaging the valve seal assembly with the valve seat into the compressively engaged state such that at least a portion of the seal strike surface of the seal compressively engages with the strike face of the valve seat.
